(19) United States
(12) Patent Application Publication
(10) Pub. No.: US 2016/0110728 A1
(43) Pub. Date: Apr. 21, 2016

(54) ENHANCED DATA COLLECTION, PROCESSING, AND ANALYSIS

(71) Applicant: Sybase 365, Inc., Dublin, CA (US)

(72) Inventors: Steven Charles Garcia, South Riding, VA (US); Khalid Abdullah, Ashburn, VA (US); Vaibhav Vohra, Mountain View, CA (US); Arturo Pedro Buzzalino, Haymarket, VA (US); Kimmo Olavi Vuori, Espoo (FI)

(21) Appl. No.: 14/701,096

(22) Filed: Apr. 30, 2015

Related U.S. Application Data
(60) Provisional application No. 62/065,823, filed on Oct. 20, 2014.

(51) Int. Cl. G06Q 30/02

(52) U.S. Cl. CPC G06Q 30/0201

(57) ABSTRACT

A method and corresponding apparatus configured to receive data from a plurality of wireless devices. The collected data includes recorded activity at the wireless devices. The method includes analyzing the collected data to produce demographic data. The analyzing includes calculating, based on the collected data, probabilities of individual steps in a path. Each step represents a visit to a website in the path or a physical location in the path. The demographic data is supplied to a data consumer device.

### RELATED APPLICATIONS

This application claims priority to U.S. Patent Application Ser. No. 62/065,823, filed on Oct. 20, 2014, the content of which is incorporated herein in its entirety.

### TECHNICAL FIELD

The present disclosure relates to data collection, processing, and analysis, and, in particular, to the collection, processing, and analysis of data from various data producers including inter alia telecommunication operators or carriers such as, among others, cellular, wireless, mobile, etc. telephone and data service providers.

### BACKGROUND

There are more mobile devices in the world today than there are people. The proliferation of mobile devices has changed significantly the ways in which people communicate, live, and engage with others at work and in their personal lives. For example, the proliferation of smart devices has significantly changed the behavior of mobile-enabled consumers in connection with how they interact with, for example, companies and brands. As more and more consumers become connected around the world through mobile devices, smartphones, the Internet, etc., all of these interactions create massive quantities of data. As well, the continuing evolution of Internet of Things (IoT)/Machine-to-Machine (M2M) initiatives, with among other things the possibility of millions if not billions of additional connected devices, creates additional massive quantities of data. The sheer volume, scale, velocity, etc. of all of the data has made effective analysis difficult.

### BRIEF DESCRIPTION OF THE DRAWINGS

FIG. 1 illustrates aspects of an exemplary environment in which embodiments of the enhanced data collection, processing, and analysis described herein may be implemented.

FIG. 2 illustrates various exchanges and interactions that might take place in connection with a registration process associated with embodiments of enhanced data collection, processing, and analysis described herein.

FIG. 3 depicts various network elements in an Operating Environment (OE) that are leveraged in connection with performing enhanced data collection, processing, and analysis consistent with the embodiments described herein.

FIG. 4 extends a hypothetical OE depicted in FIG. 3 to highlight possible Mediation Zones (MZs) within which aspects of a Processing Environment (PE) may reside.

FIGS. 5a and 5b depict aspects of a hypothetical Data Producer (DP) and aspects of a hypothetical Service Provider (SP).

FIG. 6 illustrates an architectural overview of one possible implementation of the data collection, processing, and analysis described herein, including functionality exposed to a Data Consumer (DC).

FIGS. 7a-7j illustrate example user interface screens consistent with embodiments described herein.

FIGS. 8a and 8b illustrate example data, etc. models that may be used in connection with the enhanced data collection, processing, and analysis techniques described herein.

FIG. 9 illustrates an example computer and telecommunications hardware and software infrastructure capable of implementing the enhanced data collection, processing, and analysis techniques described herein.

FIGS. 10a-10c illustrate aspects of a virtual cell.

FIGS. 11a-11c illustrate different depictions of a “digital journey.”

### DESCRIPTION OF EXAMPLE EMBODIMENTS

### Overview

For simplicity of exposition the discussion below will focus principally on telecommunications providers generally and mobile operators specifically. It will be readily apparent to one of ordinary skill in the relevant art that numerous other contexts are easily possible.

The enhanced data collection, processing, and analysis apparatus and corresponding methodologies described herein (referred to also as “SAP Consumer Insight 365,” “Consumer Insight 365,” “Consumer Insight,” or simply “CI”) leverage various of a mobile operator's data sources to inter alia identify patterns, consumer demographic trends, activities, etc. providing among other things actionable market intelligence, a deeper and more accurate/insightful/etc. understanding of consumer behavior, monetization opportunities, etc. CI may source this data from mobile operators worldwide to provide users with rich, reliable consumer behavior and insight analytics and analyses services. Results are delivered to users through inter alia a smart portal with quick intuitive service packages utilizing among other things simple subscription models.

CI may be implemented as any combination of premise-based services and/or cloud-based services and may be powered by SAP HANA® or any other underlying database infrastructure that enables the types of storage, processing, and analysis activities described herein. Mobile operator data may be stored discreetly and individually partitioned within secure cloud data centers and CI onsite appliances. A user friendly customer access portal makes cleansed, clustered, aggregated, etc. data sets available to end users.

CI supports near real time understanding and awareness within mobile data usage, trends and patterns. This provides operators, retailers, researchers, advertising/marketing companies, etc. with a comprehensive market (“Big Picture”) view of inter alia dynamically changing market opportunities within desired market footprints. The types of information and analysis that may be provided include inter alia:

1) Marketing and behavioral based demographic movement and mobile activities by macro/micro location and targeted advertising polling analysis;

2) Communication pattern (Short Message Service (SMS)/Multimedia Message Service (MMS)/etc. messaging, (click stream, etc.) data, call activity, etc.) analysis to identify specific opportunity decision maker groups and locations;

3) Patterns over time may provide predictable trends and the ability to rank by the frequency of interaction with consumer's browsing, apps, tethering, locations trends and others;

4) Consumer's preferences and trends by locations, browsing and social patterns;

5) New user understanding by location, preferences, interests, activities implemented through user models;

6) Consumer event predictions (such as for example “about to purchase,” “about to leave,” “advertisement acknowledgement,” etc.) and impending purchase behavior change scenarios (e.g., coupon or discount delivery, etc.);

7) Mobile marketing, advertising campaign, short code, coupon, discount, etc. effectiveness and return on investment performance;

8) Consumer roaming/movement, search, purchase, etc. activities in support of retail site selection/renewal/etc., competitor benchmarking, etc.

9) Consumer search, messaging, posting, etc. activities in support of political, sports, entertainment, etc. events;

10) Consumer search, purchase, etc. activities in support of “hole in basket” analysis (e.g., identifying, determining, quantifying, etc. how/when/why a consumer secures or completes other purchases or acquisitions); and/or

11) Social, public health, epidemiological, etc. insight.

A CI service offering thus may allow enterprises to gain insight from the processing and analysis of massive amounts of aggregated and anonymized data residing in inter alia operator networks in real time. This market intelligence may enable brands to strengthen relationships with consumers through more targeted and context-specific marketing efforts.

The narrative that was presented above is illustrative only and it will be readily apparent to one of ordinary skill in the relevant art that numerous variations, alternatives, etc. are easily possible.

### Example Embodiment

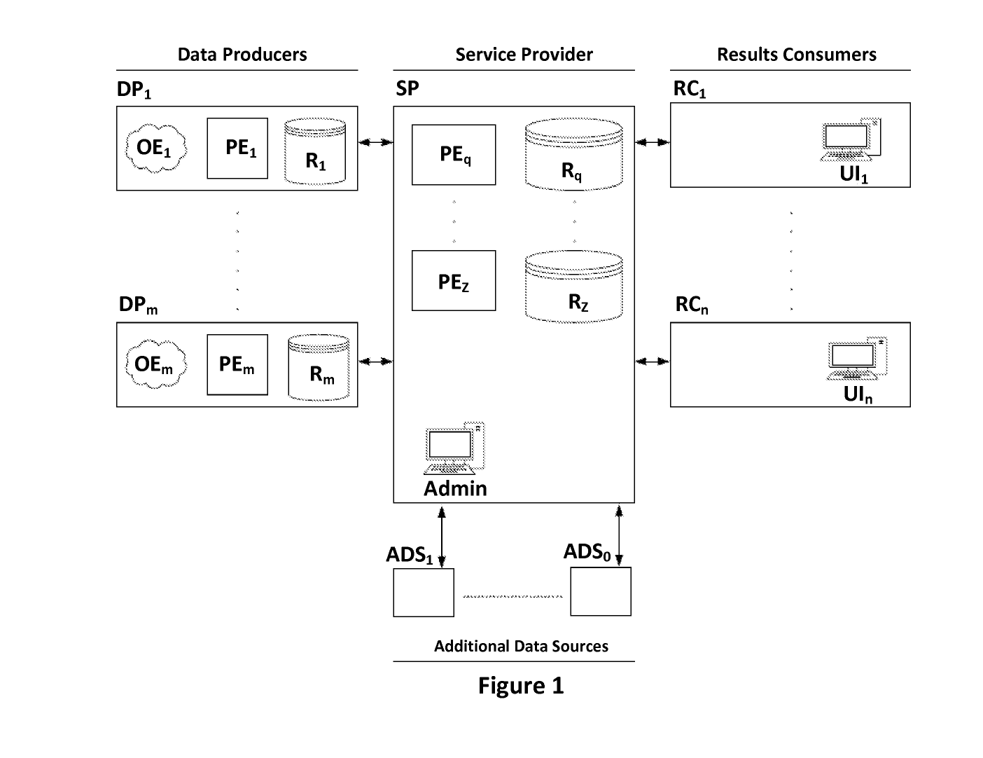

FIG. 1 depicts an exemplary Operating Environment (OE) in which aspects of CI may operate. The environment that is illustrated in FIG. 1 comprises:

Data Producers (DPs) such as DP₁→DPₘ;

A Service Provider (SP); and

Data Consumers (DCs) such as such as DC₁→DCₙ.

It is important to note that the particulars of FIG. 1 (such as for example the specific components that are presented, the component arrangement that is depicted, etc.) are illustrative only and it will be readily apparent to one of ordinary skill in the relevant art that numerous alternatives (including inter alia other or different components, alternative component arrangements, etc.) are easily possible.

For example and inter alia, for simplicity of exposition only one SP is depicted in FIG. 1. Multiple SPs are indeed possible—to inter alia provide for redundancy, enhanced performance (through for example the distribution of workload), etc.—and may be exposed in different fashions—e.g., individually, through a shared interface as a single logical/virtual SP, etc.

### Data Producers

A Data Producer (DP) is an entity that, for example during the normal course of its operations, generates (business, activity, transaction, etc.) data.

A DP may be, for example, any combination of one or more of inter alia a telecommunications provider such as a landline operator or carrier or a mobile operator or carrier, an Internet Service Provider (ISP), a credit card clearinghouse or other financial institution, a social media operation, a retail operation, etc.

Among other things a DP may comprise an Operating Environment (OE, such as OE₁ and OEₘ in FIG. 1) which possibly inter alia supports a DP's normal operations.

Within a telecommunications context a DP's OE might comprise data of various types including for example any combination of one or more of possibly inter alia:

1) Structural Data. Such as for example information on cell towers, antennas, etc. (including for example and inter alia identifiers, coverage strength/geometry/etc., capabilities, etc.), Short Message Service Centers (SMSCs), Multimedia Message Service Centers (MMSCs), Mobile Switching Centers (MSCs), gateways, network interfaces, etc.

2) Subscriber Data. Such as for example subscriber identifiers; service provisioning details; personal characteristics (if allowed) like age, gender, etc.; device information like identifiers, vendor, type, features and capabilities, Type Allocation Code (TAC), etc.; etc.

3) Activity Data. Such as for example data from signaling, roaming, registration, voice, data, Internet access and utilization information, Wireless Application Protocol (WAP), mobile application downloading/usage/etc. information, (SMS/MMS/ Internet Protocol (IP) Multimedia Subsystem (IMS)/etc.) messaging, lookup, location, Wi-Fi, Near Field Communication (NFC), 3G/4G/5G/etc., Long-Term Evolution (LTE), Radio Frequency Identification (RFID), call/event/message/etc. detail record information, etc.

4) Generated Data. Such as for example billing records, etc.

As just one example, for the case where a DP is a mobile operator or carrier:

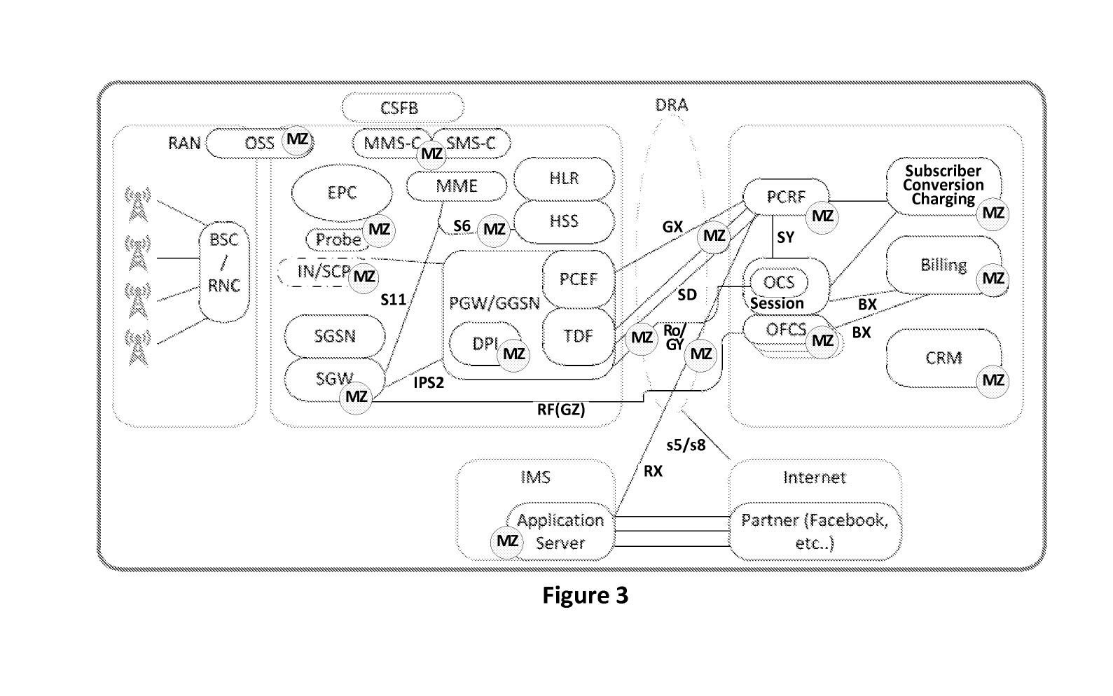

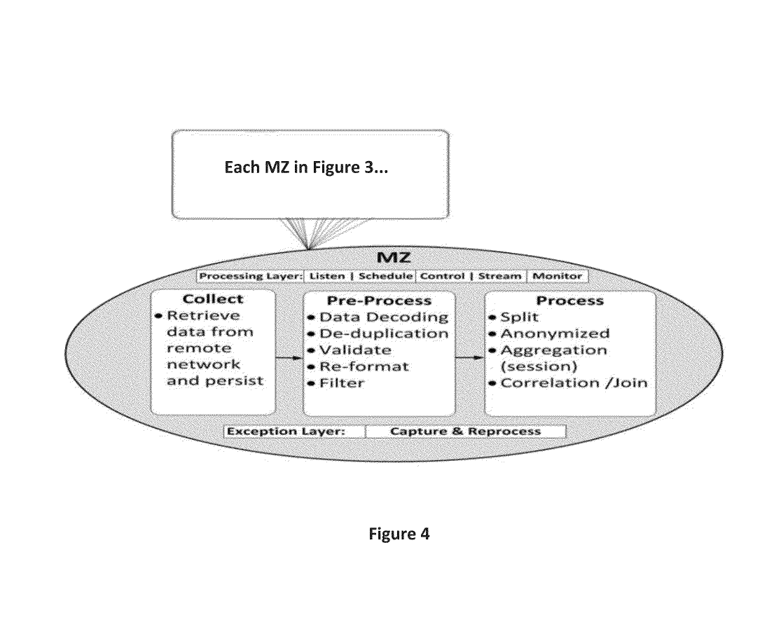

1) FIG. 3 depicts various of the network elements—Base Station Controller (BSC), Circuit-Switch Fallback (CSFB), Evolved Packet Core (EPC), Gateway GPRS Support Node (GGSN), Home Location Register (HLR), Home Subscriber Server (HSS), IP Multimedia Subsystem (IMS), Intelligent Network/Service Control Point (IN/SCP), Multimedia Exchange (MME), Multimedia Messaging Service (MMS), Online Charging System (OCS), Offline Charging System (OFCS), Policy and Charging Enforcement Function (PCEF), Policy and Charging Rules Function (PCRF), PDN Gateway (P-GW), Radio Access Network (RAN), Radio Network Controller (RNC), Serving GPRS Support Node (SGSN), Serving Gateway (S-GW), Short Message Service (SMS), and Traffic Detection Function (TDF), etc.—that are typically found within the OE of a mobile operator or carrier.

2) FIG. 4 extends the hypothetical OE that was presented in FIG. 3 to (a) highlight possible Mediation Zones (MZs) within which aspects of a PE may reside and (b) identify various of the activities that may take place within a PE.

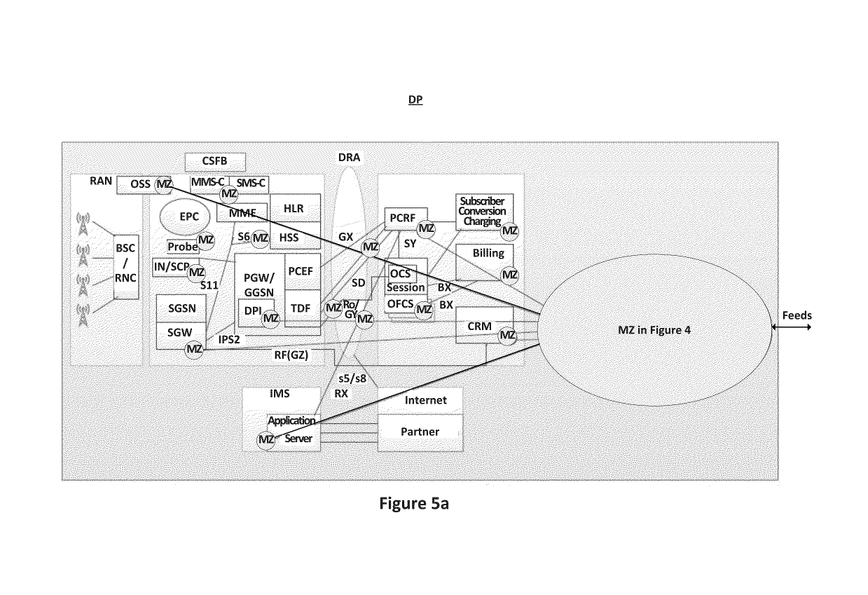

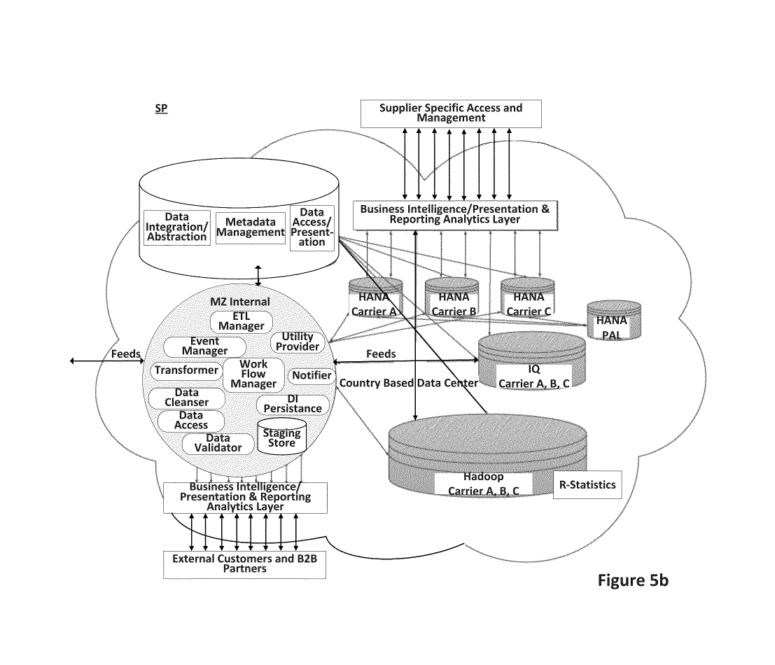

3) FIGS. 5a and 5b depict aspects of a hypothetical DP, aspects of a hypothetical SP, and one possible relationship between same.

A DP may comprise inter alia one or more Processing Environments (PE, such as for example PE₁→PEₘ in FIG. 1), each of which may comprise inter alia various processing elements such as for example computer platforms, application software, connectivity, etc., and one or more repositories (R, such as for example R₁→Rₘ in FIG. 1), each of which may comprise inter alia various storage elements such as for example databases, files, etc.

Among other things a PE may pull, extract, receive, etc. data from different components, elements, systems, etc. of a DP's OE, along with possibly data from other sources internal to a DP and/or external to a DP, and then inter alia process that data.

A PE may support inter alia:

1) A management or administration facility through which inter alia operations may be controlled, scheduled, monitored, etc. Such a facility may comprise one or more of (e.g., web-based) user interfaces, Application Programming Interfaces (APIs), management frameworks (such as for example Tivoli), etc.

2) Various data extraction, collection, manipulation, preprocessing, processing, error reporting and correction, etc. operations including possibly inter alia:

a) Cleansing, smoothing, editing, etc. to for example and inter alia remove spurious data (e.g., noise, etc.), address threshold-based actions (such as for example pass/drop), etc.

b) Anonymization to for example and inter alia provide privacy protections by among other things replacing identification values (such as for example telephone number, etc.) with opaque (e.g., possibly system-generated) values;

c) Aggregation to for example and inter alia provide further privacy protections (by for example selectively combining or clustering individual, user, subscriber, etc. data);

d) Formatting to for example and inter alia (i) account for the disparate formats, structures, etc. of source systems, components, etc. and (ii) account for the format, structure, etc. of how data will be conveyed to an SP;

along with, possibly among other things, edit and validation operations, encoding and/or decoding operations, data alteration or replacement or substation activities, de-duplication activities, filtering, etc. with aspects of the above activities possibly managed by, controlled by, scheduled within, etc. a workflow facility incorporating inter alia flexible, extensible, and dynamically configurable rules, definitional artifacts, logic, etc.

3) Interacting with an SP. Such interactions may employ any combination of one or more mechanisms including possibly inter alia an API, an Electronic Data Interchange (EDI) facility, (open, secured, etc.) File Transfer Protocol (FTP), File eXchange Protocol (FXP), one or more proprietary or standards-based application-level and/or transport-level protocols, a publish-subscribe paradigm, a push-pull model, file exchanges, a (courier, overnight, etc.) delivery service, postal mail, etc. and may utilize among other things Extensible Markup Language (XML) documents, Comma-Separated Values (CSV) files, name-value pairs, etc.

Such mechanisms may comprise one or more servers, gateways, interfaces, etc. and may leverage inter alia any combination of a dedicated communication circuit, the open Internet, a Virtual Private Network (VPN), etc. and may include various security mechanisms (such as access credentials, etc.).

Such interactions may comprise various messages, including inter alia any combination of one or more of a request message, a response message, a status or inquiry message, a confirmation message, etc. Such messages may be generated on a scheduled basis, on an ad hoc (e.g., as needed) basis, etc.

The activities of enumerated Item 2 above may be controlled, managed, driven, etc. by a suite of flexible, extensible, and dynamically configurable rules. Rules may exist for inter alia (local, regional, national, global, etc.) privacy requirements; each data source system, component, etc.; data manipulation, alteration, formatting, etc. operations (e.g., “if occurs within a X second window combine individual events to create a single event,” etc.); etc.

The activities of enumerated Item 2b above—anonymization—may comprise for example any combination of one or more of static mechanisms (e.g., leveraging one or more lookup/etc. lists, etc.), dynamic mechanisms (e.g., incorporating one or more mapping/etc. algorithms such as inter alia Advanced Encryption Standard (AES), Data Encryption Standard (DES, cryptographic hash functions, one-way functions, etc.), random mechanisms, etc.; may be dynamically configurable; may be rule based (e.g., ‘if less than X instances/occurrences within a defined time period then don't include’ so re-identification is precluded); may incorporate one or more security/access/etc. features; may employ one or more access, control, cryptographic, etc. values (such as keys, etc.); and may inter alia address global and/or geography-specific legal, regulatory, etc. frameworks.

The activities of enumerated Item 2b above—anonymization—may operate on any combination of one or more identifiers such as for example and inter alia DP subscriber identifier, MSIDSN, MDN, IMSI, MIN, ICCID, IMEI, MEID, etc.

The activities of enumerated Item 2 above may leverage any number of optimization strategies to for example improve processing efficiency, reduce memory consumption, etc.

A PE may comprise inter alia any combination of one or more of local or on-premise resources, cloud-based resources, etc.

The PE repositories that were referenced above may comprise any combination of one or more of a Relational Database Management System (RDBMS), an Object Database Management System (ODBMS), an in-memory Database Management System (DBMS), specialized facilities such as SAP HANA or Sybase IQ, a data storage and management facility (such as inter alia Hadoop), different storage paradigms (such as inter alia federation), etc.

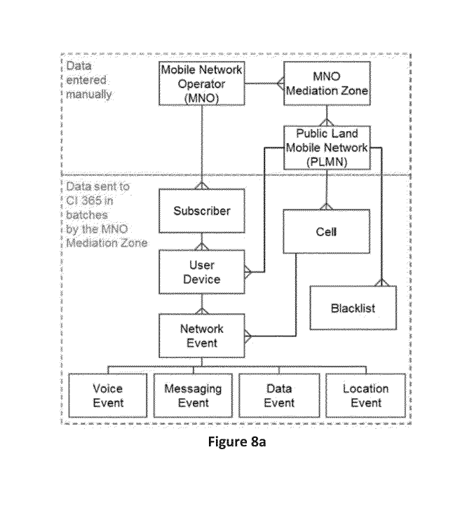

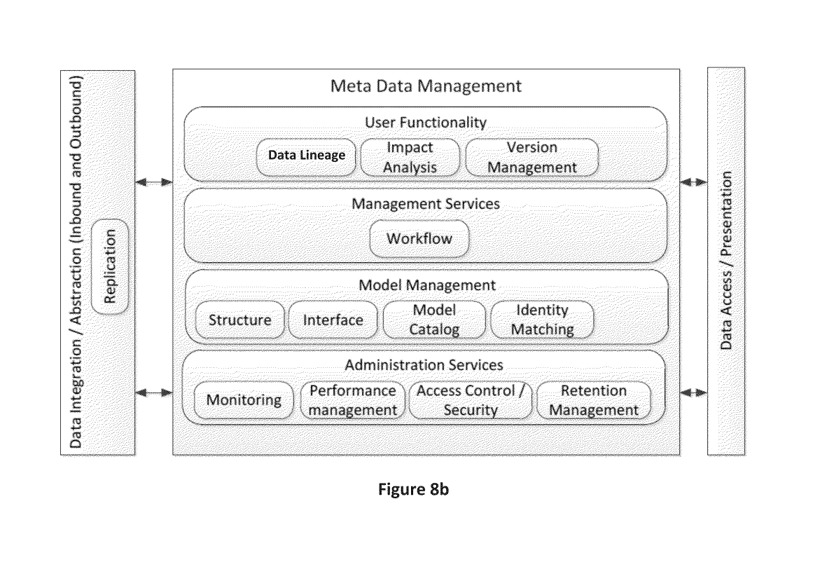

Such repositories may support one or more data models (logical, physical, etc.) data models. See for example FIGS. 8a and 8b.

FIG. 8a shows an example data model illustrating relationships between various entities such as subscribers, user devices, a Mobile Network Operator (MNO), MNO Mediation Zones, Public Land Mobile Networks (PLMNs), cells, network events and blacklists. In FIG. 8a, data may be collected by the various MNO MZs and sent to the Consumer Insight system, e.g., in periodic batches or on demand. This data may concern the subscribers, user devices, cells, network events or blacklists.

A subscriber may be an individual that purchased mobile services from an MNO. Subscriber information may include the subscriber's age or age band, gender, home location, etc. or information concerning the subscriber's contract with the MNO.

User devices may include cell phones, smart phones, tablets and other equipment that hold data about an individual user, e.g., a subscriber. Users may be identified by an anonymized version of their telephone number.

A cell may be an individual transmitter or a base station, which connects a device to an MNO's network. Cell information may include information about a cell location and its coverage.

Network events may include detailed records of a single communication of data between a device and a cell at a specific point in time. Each voice call, SMS/MMS message, web/data activity, or other data generating activity such as a detected movement of the device may include multiple associated network events. Network events may be classified as one of four types: voice events, message events, data events and location events.

Blacklists may include lists of IP addresses, website domain names and/or web resources which are blacklisted by an MNO, and therefore excluded from analysis by the Consumer Insight system.

FIG. 8b shows an example data model illustrating meta data management. The model includes the following components: User Functionality (e.g., data lineage and impact analysis capabilities), Management Services (e.g., workflow), Model Management (e.g., a model catalog and identity matching), Administrative Services (e.g., monitoring and access control/security), Data Integration/Abstraction (e.g., replication), and Data Access/Presentation.

It is important to note that the particulars of those models (such as for example the specific data model and data model elements that are presented in FIGS. 8a and 8b, the arrangements that are depicted, etc.) are illustrative only and it will be readily apparent to one of ordinary skill in the relevant art that numerous alternatives (including inter alia other or different data models and/or data model elements, alternative arrangements, etc.) are easily possible.

### Service Provider

A Service Provider (SP) is an entity that inter alia (1) receives, collects, etc. data from one or more DPs, (2) performs a range of pre-processing and/or processing operations, and (3) supports the reporting, analysis, etc. needs of one or more DCs.

An SP may, for example, be realized as an independent service bureau, an element of or within some organization (such as possibly inter alia a financial institution, a retail establishment, an on-line retailer, a corporate entity, etc.), multiple entities (such as for example those just listed) or aspects of same working together, etc. It will be readily apparent to one of ordinary skill in the relevant art that numerous other arrangements are easily possible.

An SP may comprise inter alia one or more Processing Environments (PE, such as for example PE_{q}→PE_{z} in FIG. 1), each of which may comprise inter alia various processing elements such as for example computer platforms, application software, connectivity, etc., and one or more repositories (R, such as for example R_{q}→R_{z} in FIG. 1), each of which may comprise inter alia various storage elements such as for example databases, files, etc.

A processing element may comprise inter alia computer platforms, application software, connectivity, etc., along with optional associated files/stores/etc., that support among other things a range of processing activities including among other things the examination, parsing, augmentation, manipulation, replacement, checking, editing, validation, mapping, aggregation, enhancement, etc. of one or more elements of received data with the optional preservation of aspects of the results, outcome, etc. of various of the activities in for example one or more repositories.

During various of the processing activities that were described above, one or more predictions, assessments, rankings, aggregations, etc. may be developed, refined, augmented, etc. including for example and inter alia subscriber particulars (e.g., gender, age, home location, shopping habits, work habits, preferences, etc.), brand particulars (e.g., rankings, conversion percentages between artifacts such as Uniform Resource Identifiers (URIs) like a Uniform Resource Locator (URL)), etc. For example and inter alia:

1) Catchment. For example, a summary of consumers that are present at one or more locations (e.g., a Point of Interest (POI), a street, a neighborhood, a town or city, a custom/arbitrary/etc. geographic region, etc.) within one or more time periods and, inter alia, an indication of where those consumers came from (e.g., an immediately-prior location, a home or origination location, etc.). Calculations, determinations, etc. may include inter alia a configurable ‘dwell time’ (e.g., length of stay) value.

2) Footfall. For example, foot traffic to, around, etc. one or more locations (e.g., a particular POI such as inter alia a shopping center, sport venue, city or town, airport, historic location, a custom/arbitrary/etc. geographic region, etc.) within one or more time periods identifying particulars such as for example customer type, arrival time, departure time, dwell time, activity while present (e.g., voice calls, messaging, data usage, browsing, etc.), etc. Customer type may encompass for example any combination of one or more of domain (e.g., Facebook, etc.), gender, age, socio-demographic factors, income, household size, etc. with optional clustering around any one or more of inter alia dwell time, input rate (the rate at which a particular customer type entered), output rate (the rate at which a particular customer type departed), etc.

3) Brand Value Index (BVI). For example, a measure of an entity's (e.g., company, etc.) standing (‘footprint’) within its respective market, operating sphere, etc. across one or more time periods based on various factors such as for example consumer sentiment (for an entity's product(s), etc.). One way in which a BVI may be calculated is from the following formulas for Click percentage per competitor and Subscriber percentage per competitor:

$${C}_{i} = \frac{{c}_{i}}{{\sum }_{i = 1}^{n} {c}_{i}} \times 100 , {S}_{i} = \frac{{s}_{i}}{{\sum }_{i = 1}^{n} {s}_{i}} \times 100 , and {BVI}_{i} = ( {C}_{i} + {S}_{i} ) \div 2 ,$$

where n is the number of competitors in the market,
Cᵢ is the percentage of clicks of competitor i,
cᵢ is the number of clicks of competitor i,
Sᵢ is the percentage of subscribers of competitor i, and
sᵢ is the number of subscribers of competitor i.

Another formula for BVI is:

BVIᵢ=Cᵢ+DSᵢ+DDᵢ+PDᵢ+ACᵢ+PSᵢ+PDSᵢ+PBRᵢ+DRRᵢ+PRRᵢ−DBRᵢ

The individual terms in the above formula may be calculated as follows:

$${C}_{i} = \frac{{c}_{i}}{{\sum }_{i = 1}^{n} {c}_{i}} \times 100 , {DS}_{i} = \frac{{ds}_{i}}{{\sum }_{i = 1}^{n} {ds}_{i}} \times 100 , \\ {DD}_{i} = \frac{{dd}_{i}}{{\sum }_{i = 1}^{n} {dd}_{i}} \times 100 , {PD}_{i} = \frac{{pd}_{i}}{{\sum }_{i = 1}^{n} {pd}_{i}} \times 100$$

$${AC}_{i} = \frac{{ac}_{i}}{{\sum }_{i = 1}^{n} {ac}_{i}} \times 100 , \\ {PS}_{i} = \frac{{ps}_{i}}{{\sum }_{i = 1}^{n} {ps}_{i}} \times 100 , \\ {PDS}_{i} = \frac{{pds}_{i}}{{\sum }_{i = 1}^{n} {pds}_{i}} \times 100 , \\ {DBR}_{i} = \frac{{dbr}_{i}}{{\sum }_{i = 1}^{n} {dbr}_{i}} \times 100 , {PBR}_{i} = \frac{{pbr}_{i}}{{\sum }_{i = 1}^{n} {pbr}_{i}} \times 100 , \\ {DRR}_{i} = \frac{{drr}_{i}}{{\sum }_{i = 1}^{n} {drr}_{i}} \times 100 , {PRR}_{i} = \frac{{prr}_{i}}{{\sum }_{i = 1}^{n} {prr}_{i}} \times 100 ,$$

where n is the number of competitors in the market,
Cᵢ is the percentage of clicks of competitor i,
cᵢ is the number of clicks of competitor i,
DSᵢ is the percentage of digital subscribers of competitor i,
dsᵢ is the number of digital subscribers of competitor i,
DDᵢ is the percentage of average digital dwell time for competitor i,
ddᵢ is the average digital dwell time for competitor i,
PDᵢ is the percentage of average physical dwell time for competitor i,
pdᵢ is the average physical dwell time for competitor i,
ACᵢ is the percentage of average clicks per session for competitor i,
acᵢ is the average clicks per session for competitor i,
PSᵢ is the percentage of physical subscribers for competitor i,
psᵢ is the number of physical subscribers for competitor i,
PDSᵢ is the percentage of physical plus digital subscribers for competitor i,
pdsᵢ is the number of physical plus digital subscribers for competitor i,
DBRᵢ is the percentage digital bounce rate for competitor i,
dbrᵢ is the number of digital subscribers that viewed one page, over total entries to page for competitor i,
PBRᵢ is the percentage of physical bounce rate for competitor i,
pbrᵢ is the number of physical subscribers that stayed on the POI for no more than ten minutes, over all subscribers for competitor i,
DRRᵢ is the percentage digital return rate for competitor i,
drrᵢ is the number of digital subscribers that returned to the page within a week, over all subscribers for competitor i.
PRRᵢ is the percentage physical return rate for competitor i, and
prrᵢ is the number of physical subscribers that returned, overall all subscribers for competitor i.

4) Clickstream. For example, an analysis of a device user's clickstream activity. Such an analysis may comprise one or more sessions (representing periods of time during which a device user was accessing the Internet). A session may comprise, possibly among other things, one or more chains, with each chain having a discrete beginning, capturing all of the user ‘click’ activity (sites visited, history, progression, etc.), and having a discrete end. As just one example, for a device user who accessed Facebook.com, then browsed over to CNN.com, but later visited ESPN.com two chains might be generated:

A) Facebook.com←→CNN.com, and

B) ESPN.COM←→

Such an analysis may include for example any combination of one or more of conversion rates between visited websites, filtering (by for example website categories, visitor age, visitor dwell time, etc.), website associations (to for example socio-demographic information, etc.), a list of the most frequently visited websites, etc. Conversion rate may be measured as a percentage or proportion of visits to a website that involve some visitor activity in response to prompting by a marketer entity, e.g., clicking on a banner advertisement.

5) Cohorts. For example, the creation and evolution of groups of consumers based on for example a shared characteristic (e.g., supporters of a sports team, place of work, hobby, political orientation, etc.).

Aspects of the above may include (e.g., develop counts, totals, etc. for) one or more topographic regions (e.g., square, rectangle, circle, triangle, polygon, irregular shape, etc.).

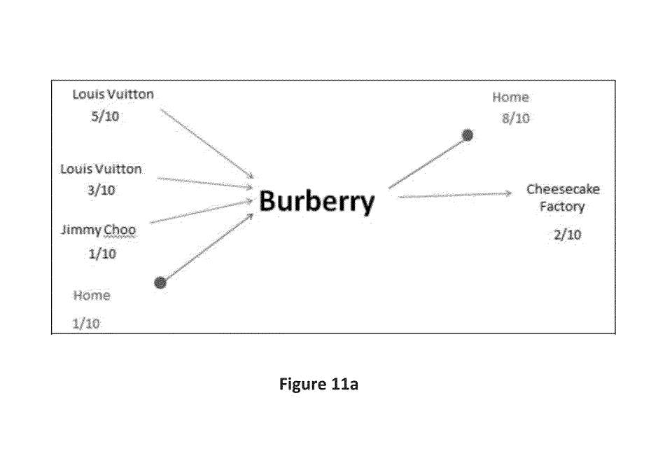

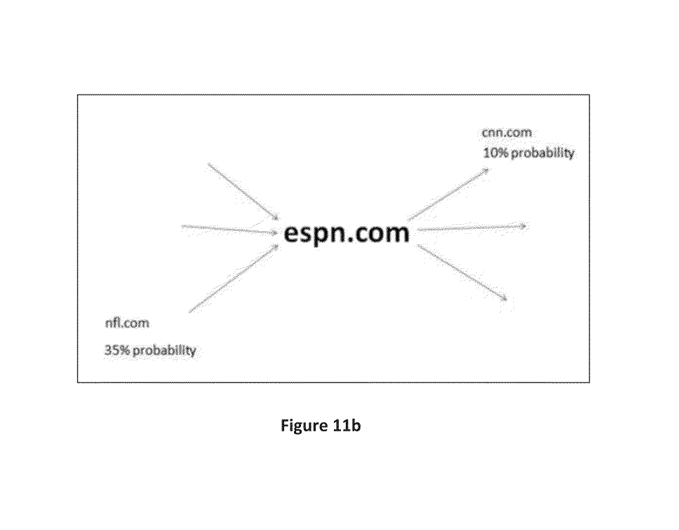

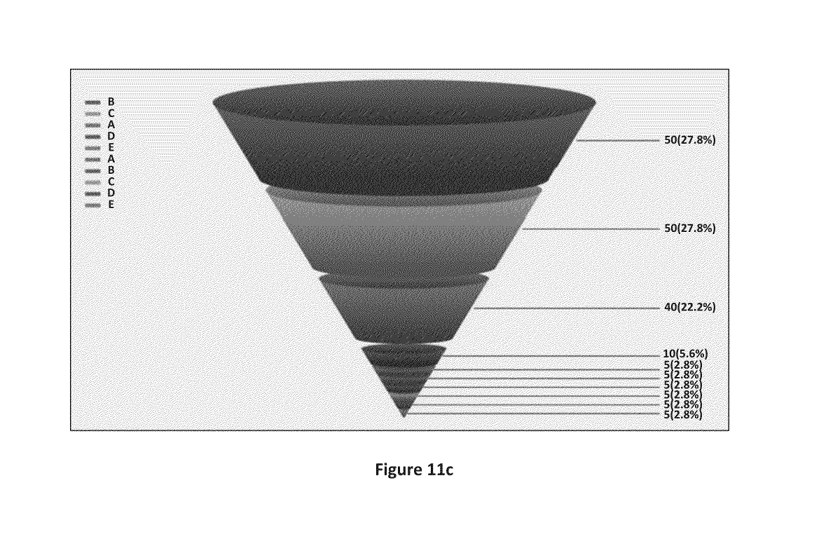

Aspects of the above may be utilized to develop insight into a device user's “digital journey” (in support of among other things subsequent display, presentation, etc. such as in for example FIGS. 11a-11c) with inter alia various measures associated with each step along a journey or path. Additionally, various probabilities, percentages, etc. may be developed (such as for example “a device user at site X has a Y% likelihood of transitioning to site Z”) that may be applied to inter alia predict device user behavior, activity, etc. (in connection with among other things targeted advertising, context-specific marketing efforts, etc.). FIG. 11b shows a potential journey in which NFL.COM, ESPN.COM and CNN.COM are connected, with a percentage probability of going from one site to its connected site shown (e.g., 35% chance that a visitor to NFL.COM will visit ESPN.COM). The above mentioned probabilities, percentages, etc. may also be developed to describe physical movements, e.g., as shown in FIG. 11a. The percentages/probabilities may be displayed in other forms besides being overlaid on a network graph (e.g., as shown in FIGS. 11a and 11b). For example, they may be shown as a pie chart, a bar graph or, as shown in FIG. 11c, a cone chart.

Aspects of the above may incorporate inter alia information on one or more physical cells and/or virtual cells. A virtual cell may be derived, mapped, generated, calculated, etc. from inter alia one or more of aspects of a DP's environment (e.g., physical cells, antenna locations, etc.), an actual geography, etc. using any number of algorithms, formulas, manipulations, etc. and targeting any level of size/precision (e.g., 1 km, 10 km, 100 km, etc.) and desired topography (e.g., square, rectangle, circle, triangle, polygon, irregular shape, etc.). Virtual cells may represent physical locations contained therein, e.g., POIs, streets, neighborhood, towns, and other geographic locations of interest.

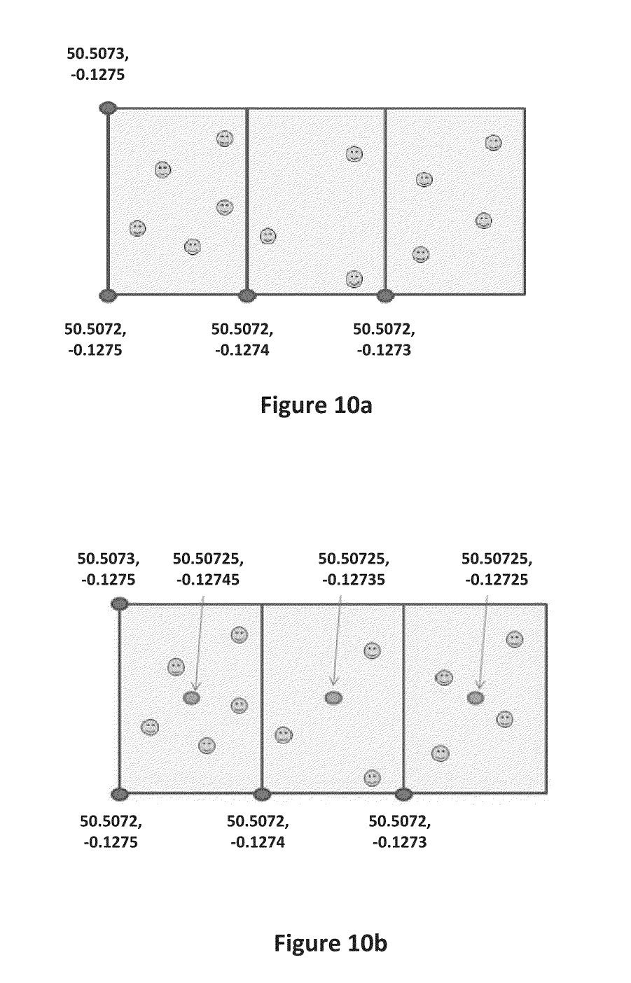

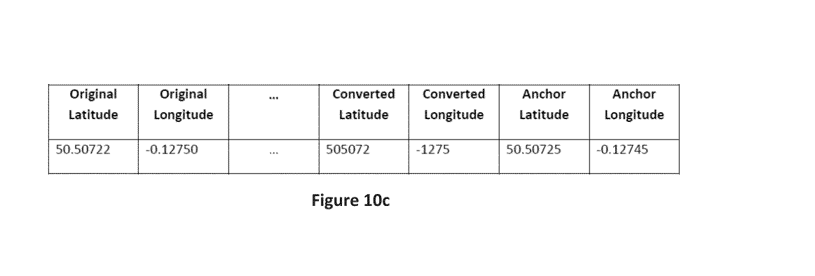

For example, the center of London is located at approximately 51:30:26 (degrees:minutes:seconds) North latitude and 0:7:39 (degrees:minutes:seconds) W longitude, or equivalently 51.50722; -0.12750 (decimal). Atop, for, etc. that geography one could establish a series of virtual cells, several of which are presented in FIG. 10a for purposes of illustration, where all device users with longitude −0.1275 and with latitude between 50.5072 and 50.5073 are included in the first cell. Among other things one may convert a cell's values into integers (to inter alia improve performance during processing, aggregation, etc.) using any number of algorithms, formulas, manipulations, etc. For example, for the first cell in FIG. 10a one might employ:

Converted Latitude=(int) trunc(original_latitude*10̂4)=505072

Converted Longitude=(int) trunc(original_longitude*10̂4)=−1275

resulting in a virtual cell id of 505072; −1275. Additionally, a 0.00005 amount may be added to each latitude and longitude to ‘anchor’ within the center of a cell (see FIG. 10b):

Anchor Latitude=trunc(original_latitude*10̂4)/10̂4+0.00005=50.50725

Anchor Longitude=trunc(original_longitude*10̂4)/10̂4+0.00005=−0.12745

to inter alia make the subsequent display, selection, etc. within a UI more precise. See also FIG. 10c.

The definition, management, etc. of virtual cells may be carried out by any combination of one or more of an SP administrator, representative(s) of a DP, etc.

Among other things any number of virtual cell definitions may be maintained for a DP, for a DC, etc. and inter alia each set of virtual cell definitions may be overlayed atop an underlying data source to for example provide different views, perspectives, scales, etc.

Various of the above may incorporate one or more extensions, etc. such as sorting, ranking, ordering, banding, trend analysis, statistical analysis, etc.

It is important to note that the specific examples that were described above are illustrative only and it will be readily apparent to one of ordinary skill in the relevant art that numerous other examples are easily possible (such as motion mapping of subscriber movements, application ranking (e.g., ranking the sales or downloads of mobile software applications), browsing path analysis, segmentation mapping of consumer markets, etc.).

The SP repositories that were referenced above may comprise any combination of one or more of a RDBMS, an ODBMS, an in-memory DBMS, specialized facilities such as SAP HANA or Sybase IQ, a Java-based in-memory facility (e.g., one in which a repository is at least partially stored as a table in an off heap database), a data storage and management facility (such as inter alia Apache Hadoop), different storage paradigms (such as inter alia federation), etc.

As an example, a single ‘logical’ view of an SP repository might be offered with, behind the scenes, a tiered physical arrangement comprising (possibly inter alia):

1) A first (e.g., perhaps SAP HANA-based) facility within which the most recent (e.g., 30 days) of data may be stored.

2) A second (e.g., perhaps SAP IQ-based) facility within which less-recent (e.g., 31 day to 60 day old) data may be stored.

3) A third (e.g., perhaps Hadoop-based) facility within which older (e.g., 61 day to 2 year old) data may be stored.

with, among other things, supporting services such as aging, roll-off, migration, access, backup and recovery, security, etc.

As an additional example, a particular repository may house data from multiple DPs. Such a repository might include inter alia appropriate data segregation, partitioning, control, security, etc. mechanisms to for example ensure that a specific DC only has visibility, access, etc. to that portion of the data to which it is authorized, subscribed, etc.

Such repositories may support inter alia one or more (logical, physical, etc.) data models. See for example FIGS. 8a and 8b. It is important to note that the particulars of those models (such as for example the specific data model and data model elements that are presented, the arrangements that are depicted, etc.) are illustrative only and it will be readily apparent to one of ordinary skill in the relevant art that numerous alternatives (including inter alia other or different data models and/or data model elements, alternative arrangements, etc.) are easily possible.

The various activities that were described above in reference to SPs, including the enumerated analysis activities 1 to 5, may be controlled, managed, driven, etc. by a suite of flexible, extensible, and dynamically configurable rules. Rules may exist for inter alia (local, regional, national, etc.) privacy requirements; each DP; each Data Consumer (DC); scheduled processing activities; data enhancements; data aggregations; etc.

Different types, classes, etc. of DC users may be possible such as for example a regular user, a super user, an administrator, etc. Each user may have inter alia an associated set of access credentials (such as for example an identifier and a password), assigned permissions, defined access rights, etc. which may employ among other things any combination of one or more of Access Control Lists (ACLs), role-based paradigms, capability-based models, etc.

An SP may comprise an administrator that inter alia provides components, rules, etc. and performs management and administration through, as just one example, a web-based interface. It will be readily apparent to one of ordinary skill in the relevant art that numerous other interfaces (e.g., a data feed, an API, etc.), management frameworks (such as for example Tivoli), etc. are easily possible.

An SP may leverage, incorporate, etc. the capabilities, features, functions, technologies, etc. of one or more external entities and/or one or more internal and/or external data sources (of for example demographic information, psychographic information, financial information, economic information, census information, marketing information, geographic information, map information, Point of Sale (POS) data, social media facilities, etc.).

### Data Consumer

A DC is an entity that supports the consumption of data through inter alia reporting, display, analysis, etc. activities. For example, a DC user might be trying to answer questions like:

1) How many 25 year old females enhance their shopping experience at lunchtime?

2) How many new devices have been activated this month?

3) What are the top 100 mobile applications?

4) Did a recent mobile media campaign deliver its expected return on investment?

5) How many foreign visitors attended a recent exhibition?

It is important to note that the questions listed above are illustrative only and it will be readily apparent to one of ordinary skill in the relevant art that numerous other, different, etc. questions are easily possible.

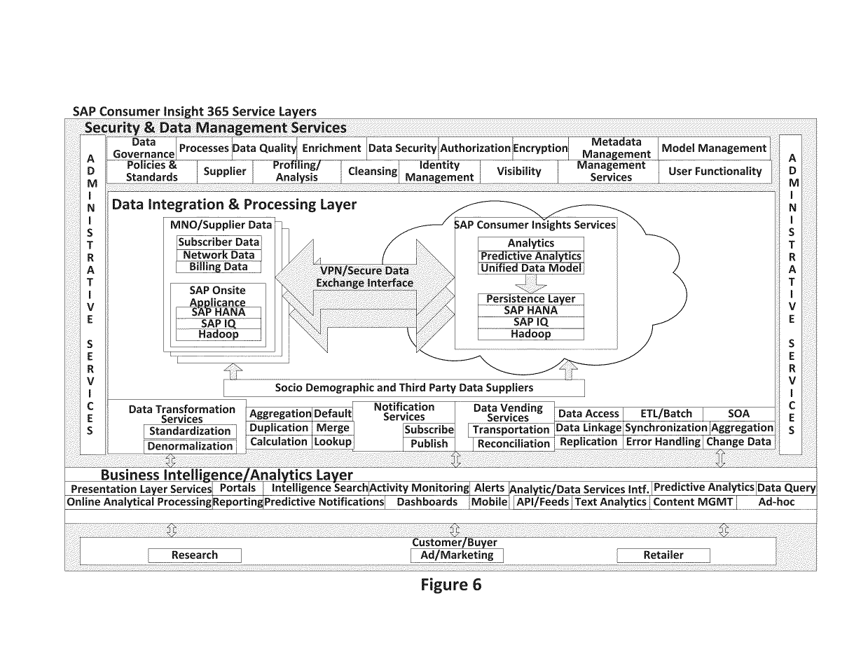

A DC may employ various applications including for example any combination of one or more of inter alia web-based applications (incorporating for example HTMLS, Cascading Style Sheets (CSS), JavaScript, etc.), hybrid applications (incorporating for example containerization, etc.), native applications, etc. FIG. 6 depicts, among other things, some of the functionality that may be exposed to a DC. The functionality in FIG. 6 includes security and data management services and administrative services. Examples, of security and data management services include data cleansing, encryption and other data security functions. Examples of administrative services include integration and collection of MNO, subscriber, network or billing data, and data analytics, e.g., predictive analytics performed on data stored using a unified data model to output alerts or reports to the DC user.

A DC may comprise any number of physical devices such as for example any combination of one or more of inter alia a wired device, a wireless device, a mobile phone, a feature phone (i.e., a low end phone with limited capabilities in comparison to a smartphone), a smartphone, a tablet computer (such as for example an iPad™), a mobile computer, a handheld computer, a desktop computer, a laptop computer, a server computer, an in-vehicle (e.g., audio, navigation, etc.) device, an in-appliance device, a Personal Digital Assistant (PDA), a game console, a Digital Video Recorder (DVR) or Personal Video Recorder (PVR), cable system or other set-top-box, an entertainment system component such as a television set, etc.

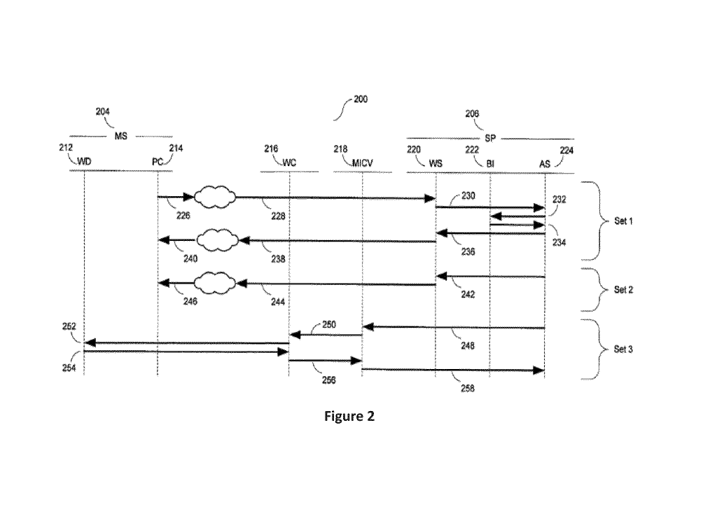

A DC user may optionally complete a registration process, as described below in connection with FIG. 2. It is important to note that a registration process may be initiated, completed, managed, etc. through any combination of one or more of channels including, inter alia, the World Wide Web (via, for example, a website that is operated by an SP), messaging paradigms (such as for example SMS, MMS, IMS, etc.), Electronic Mail (E-Mail) messages, Instant Messaging (IM), conventional mail, telephone, Interactive Voice Response (IVR) facility, etc.

A DC user may have inter alia an associated set of access credentials (such as for example an identifier and a password), assigned permissions, defined access rights, defined data visibility scope, etc.

An interaction between a DC and an SP may employ any combination of one or more mechanisms including possibly inter alia a (JSON, REST, etc.) API, an EDI facility, (open, secure, etc.) FTP, one or more proprietary or standards-based application-level and/or transport-level protocols, a publish-subscribe paradigm, a push-pull model, file exchanges, a (courier, overnight, etc.) delivery service, postal mail, etc. and may utilize among other things XML documents, CSV files, name-value pairs, etc.

Such mechanisms may comprise one or more servers, gateways, interfaces, etc. and may leverage inter alia any combination of a dedicated communication circuit, the open Internet, a VPN, etc. and may include various security mechanisms (such as access credentials, etc.).

Interactions between a DC and an SP may comprise various messages, including inter alia any combination of one or more of a request message, a response message, a status or inquiry message, a confirmation message, etc. Such messages may be generated on a scheduled basis, on an ad hoc (e.g., as needed) basis, etc.

Such interactions may employ any combination of one or more mechanisms including inter alia a (SMS, MMS, IMS, etc.) message exchange, a WAP exchange, a structured or an unstructured data transfer, a data transfer operation atop one or more proprietary or standards-based protocols, an E-Mail exchange, an IM exchange, a voice telephone call, Wi-Fi, NFC, etc.

FIG. 2 illustrates various exchanges/interactions 200 that might occur under a registration process. A registration process may be tailored (e.g., the range of information gathered, the scope of access subsequently granted, etc.) to the class of user—e.g., different types, categories, etc. of users may complete different registration processes. FIG. 2 includes the following entities:

A) MS 204 and WD 212. For example, a Wireless Device (WD) such as a mobile telephone, a BlackBerry, a PalmPilot, etc. belonging to “Mary,” a hypothetical DC user (MS) 204.

B) Personal Computer (PC) 214. For example, a home or a work PC of MS 204.

C) WC 216. The service provider for the WD 212, e.g., a mobile operator.

D) MICV 218. A messaging hub such as a Messaging Inter-Carrier Vendor (MICV). Although not required, the use of an MICV may provide certain advantages.

E) SP 206 and Web Server (WS) 220. A publicly-available website that is optionally provided by another service provider, SP 206.

F) Billing Interface (BI) 222. A single, consolidated interface that the SP 206 may employ to easily reach one or more external entities such as a credit card or debit card clearinghouse, an operator or carrier billing system, a service bureau that provides access to multiple operator or carrier billing systems, etc.

G) Application Server (AS) 224. A supportive AS environment operated by the SP 206.

While in FIG. 2 the MS 204, WD 212, MS 204 and PC 214 entities are illustrated as being adjacent or otherwise near each other, in actual practice the entities may, for example, be physically located anywhere.

In FIG. 2 the exchanges that are collected under the designation Set 1 represent the activities that might take place as the user MS 204 completes a registration process with the SP 206:

A) Mary 204 uses one of her PCs 214 to visit an SP's 206 WS 220 to, possibly among other things, complete a service registration process (226 228).

B) WS 220 interacts with AS 224 to, possibly among other things, commit some or all of the information that MS 204 provided to a data repository (e.g., a database), optionally complete a billing transaction, etc. (230).

C) As appropriate and as required a BI 222 completes a billing transaction (232 234).

D) WS 220 responds appropriately (e.g., with the presentation of a confirmation message) (238→240).

The specific exchanges that were described above (as residing under the designation Set 1) are illustrative only and it will be readily apparent to one of ordinary skill in the relevant art that numerous other exchanges are easily possible. For example, the collected information may be reviewed, confirmed, etc. through one or more manual and/or automatic mechanisms. For example, the registration process may be completed through any combination of one or more channels including, inter alia, the World Wide Web (via, for example, a website that is operated by an SP), wireless messaging (SMS, MMS, IMS, etc.), E-Mail messages, IM, conventional mail, telephone, IVR facility, etc.

During the registration process described above a range of information may be captured from an MS including, inter alia:

A) Identifying Information. For example, possibly among other things, name, address, landline and wireless Telephone Numbers (TNs), E-Mail addresses, IM names/identifiers, a unique identifier and a password, etc.

B) Preference Information. For example, information on, possibly inter alia, an MS's usage patterns, needs, etc.

C) Billing Information. Different service billing models may be offered including, inter alia, a fixed one-time charge, a recurring (monthly, etc.) fixed charge, a recurring (monthly, etc.) variable charge, etc. Different payment mechanisms may be supported including, possibly among other things, credit or debit card information, authorization to place a charge on an MS's phone bill, etc.

D) Other Information. Additional, possibly optional, information.

The specific pieces of information that were described above are illustrative only and it will be readily apparent to one of ordinary skill in the relevant art that numerous other pieces of information (e.g., additional Preference Information, scheduled daily/weekly/etc. reporting desired and/or on-demand reporting desired, etc.) are easily possible.

As noted above, the information that Mary provided during the registration process may be preserved in a data repository (e.g., a database) and may optionally be organized as an MS Profile.

The content of Mary's profile may be augmented by an SP to include, as just a few examples of the many possibilities, internal and/or external demographic, psychographic, sociological, etc. data.

As noted above, an SP's BI may optionally complete a billing transaction. The billing transaction may take any number of forms and may involve different external entities (e.g., a WC's billing system, a carrier billing system service bureau, a credit or debit card clearinghouse, etc.). The billing transaction may include, inter alia:

A) The appearance of a line item charge on the bill or statement that a MS receives from her WC.

B) The charging of a credit card or the debiting of a debit card.

C) The transfer of funds, e.g., electronically.

D) The generation of an invoice, statement, etc.

In FIG. 2 the exchanges that are collected under the designation Set 2 represent the activities that might take place as SP's 206 AS 224 dispatches to Mary 204 one or more confirmation E-Mail messages (242→246).

The specific exchanges that were described above (as residing under the designation Set 2) are illustrative only and it will be readily apparent to one of ordinary skill in the relevant art that numerous other exchanges are easily possible. For example, any of the indicated activities (such as (242 246) may be repeated any number of times.

In FIG. 2 the exchanges that are collected under the designation Set 3 represent the activities that might take place as SP's 206 AS 224 dispatches one or more confirmation SMS, MMS, IMS, etc. messages to Mary's 204 WD 212 (248 252) and Mary 204 optionally replies or responds to the message(s) (254→258).

In the example of FIG. 2, the messages are shown traversing the MICV 218.

The SP 206 may employ any number of addressing artifacts as its source address (and to which it would ask users of its service to direct any reply messages) including inter alia a Short Code (SC) or a regular telephone number.

The specific exchanges that were described above (as residing under the designation Set 3) are illustrative only and it will be readily apparent to one of ordinary skill in the relevant art that numerous other exchanges are easily possible.

The Set 1, Set 2, and Set 3 exchanges that were described above are illustrative only and it will be readily apparent to one of ordinary skill in the relevant art that numerous other exchanges are easily possible. For example, possibly inter alia, the registration information that was described above may subsequently be managed (e.g., existing information may be edited or removed, new information may be added, etc.) through any combination of one or more channels including, inter alia, an SP's WWW facility, wireless messaging (SMS, MMS, IMS, etc.), E-Mail messages, IM exchanges, conventional mail, telephone, IVR facilities, etc.

Referring again to FIG. 1, for a particular DP, PEs and Rs may reside in the DP, may reside in an SP, may reside in both the DP and an SP (e.g., in a distributed fashion) and may comprise inter alia any combination of one or more of local or on-premise resources, cloud-based resources, etc.

A PE may among other things leverage hardware (such as for example platform clustering paradigms, network traffic routing and switching mechanisms, etc.) and/or software (such as for example Operating Systems (OSs), file systems, etc.) that provide support for inter alia data intensive operations (e.g., big data, fast data, etc.).

Various of the request, response, confirmation, etc. interactions that were described above may optionally contain any combination of one or more of information elements (such as for example a relevant or applicable factoid, a piece of product information, etc.), advertisements, promotional items, coupons, vouchers, surveys, questionnaires, gift cards, retailer credits, etc. Such material may be selected statically or randomly (from for example a repository of defined material), may be location-based (for example, selected from a pool of available material based on possibly inter alia information about the current physical location of a user's device), may be product-specific, etc.

For convenience and ease of exposition a single SP is depicted in FIG. 1. Other arrangements are easily possible including for example two, three, or more SP entities (such as inter alia retailers, service bureaus, intermediaries, aggregators, software firms, etc.) performing various combinations of the SP activities that were described above and employing inter alia various traffic management (distribution, routing, etc.) capabilities in support of for example performance, disaster recovery, etc.

Various of the information that is conveyed to a DC may among other things be adapted to meet specific localization needs such as language, date and time format, etc. Such adaptations may be driven by among other things a user's preferences, information about the current physical location of a user, etc. and may leverage previously-prepared pools of material (such as for example a U.S.-specific pool of material, a U.K.-specific pool of material, a French-specific pool of material, etc.) and/or dynamically generate any localization-specific material that may become needed.

Among other things an SP may offer various reporting mechanisms including among other things scheduled (e.g., hourly, daily, weekly, etc.) reporting, on-demand reporting, scheduled (e.g., hourly, daily, weekly, etc.) data mining operations, and/or on-demand data mining operations with results delivered through any combination of one or more of (SMS, MMS, IMS, etc.) messaging, a web-based facility, E-Mail, data transfer operations, a Geographic Information System (GIS) or other visualization facility, etc. Such reporting mechanisms may draw from repositories within an SP and/or any number of data sources external to an SP.

The interactions that were described above may employ among other things various addressing artifacts such as inter alia telephone numbers, short codes, IP addresses, E-Mail address, IM handles, Session Initiation Protocol (SIP) addresses, URIs/URLs, etc.

Various of the interactions that were described above may optionally leverage, reference, etc. information on the current physical location of a user's device (e.g., WD 212) as obtained through inter alia a one or more of a Location-Based Service (LBS) facility, a Global Positioning System (GPS) facility, etc. to among other things enhance security, provide more applicable or appropriate information, etc.

The rules that were described above (e.g., in connection with a DP and/or an SP) may be created, crafted, edited, managed, etc. by a system administrator, by a user, by an application developer, etc. using among other things a Graphical User Interface (GUI) facility (that may offer among other things a What You See Is What You Get (WYSIWYG) capability), APIs, computer code libraries, etc.

Various of the interactions, activities, etc. that were described above may result in for example one or more billing, financial, etc. transactions.

Any number of revenue share plans may be supported with as just one example an SP acting as an plan administrator for all of the different entities residing upstream and/or downstream of the Service Provider and completing inter alia various billing, fund collection, fund distribution, etc. operations.

Various of the interactions that were described above comprise, leverage, employ, etc. any combination of one or more of inter alia a (SMS, MMS, IMS, etc.) message exchange, a WAP exchange, a structured or an unstructured data transfer, a data transfer operation atop one or more standards-based protocols (such as for example Transmission Control Protocol (TCP)/IP) and/or proprietary protocols, an E-Mail exchange, an IM exchange, Wi-Fi, a NFC exchange, etc.

The various interactions that were described above are illustrative only and it will be readily apparent to one of ordinary skill in the relevant art that numerous other interactions are easily possible. For example, and inter alia, any combination of a depicted interaction may be repeated any number of times.

The user registration process, described above in connection with FIG. 2, may take place through any combination of one or more channels (including inter alia a web-based interface, postal mail, telephone, etc.), may be tailored (e.g., with respect to the range of information gathered, the scope of access/privileges/etc. subsequently granted, etc.) to the class of user. For example, different types, categories, etc. of users may complete different registration processes; may gather a range of identifying, preference, billing, etc. information; and may preserve, store, etc. aspects of the gathered information in one or more repositories (e.g., databases) optionally organized as a user profile. Among other things a service provider may optionally augment a user profile with inter alia internal and/or external demographic, psychographic, sociological, financial, etc. data.

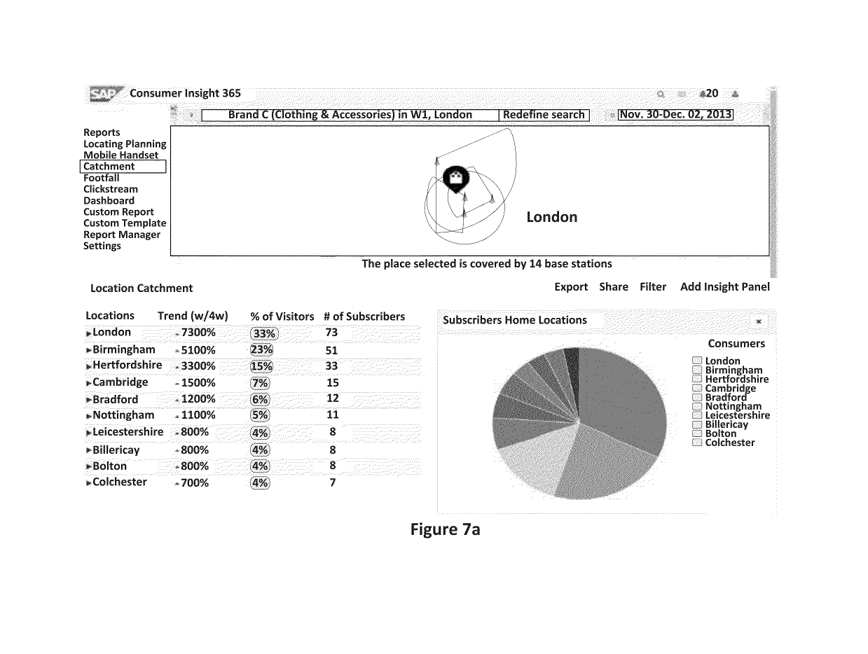

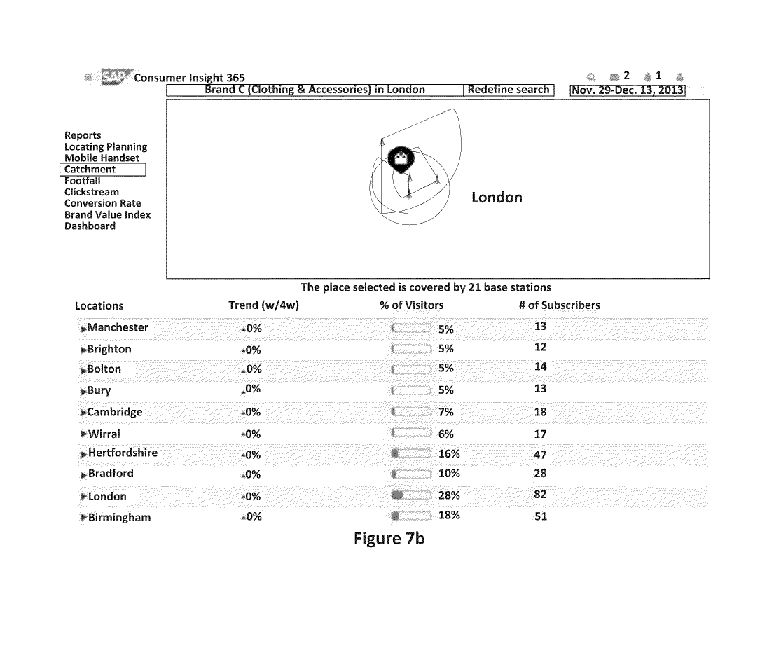

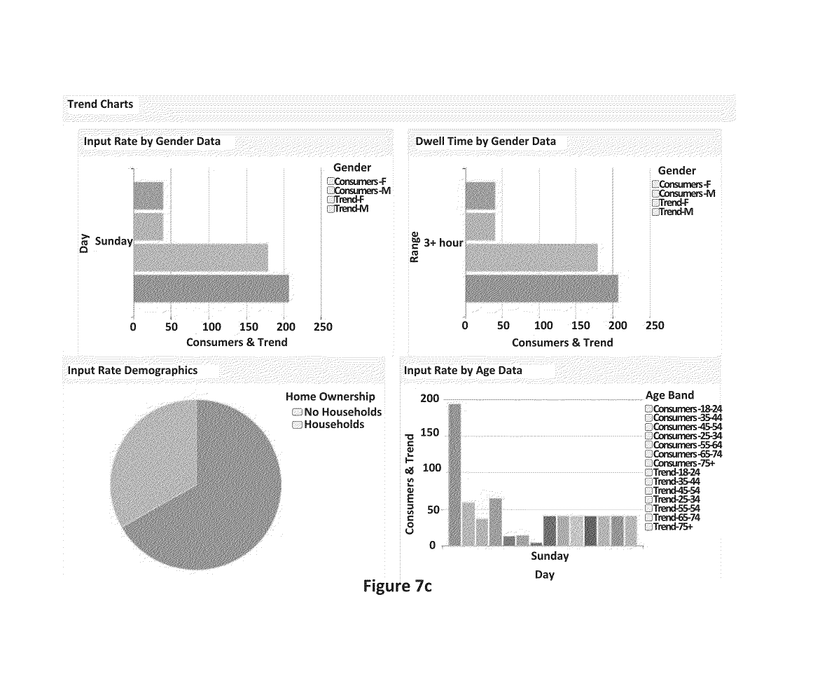

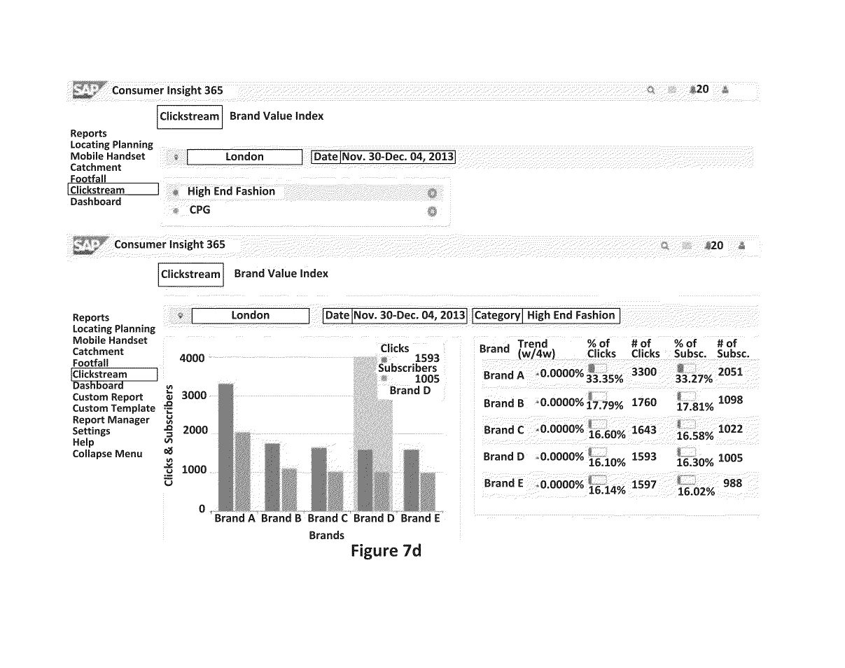

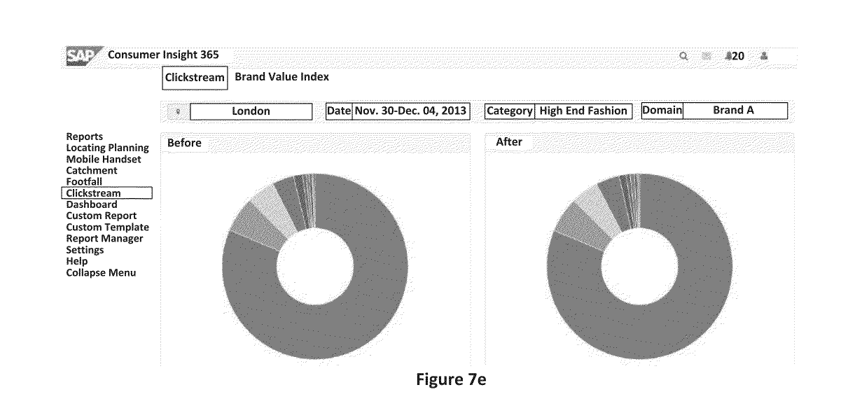

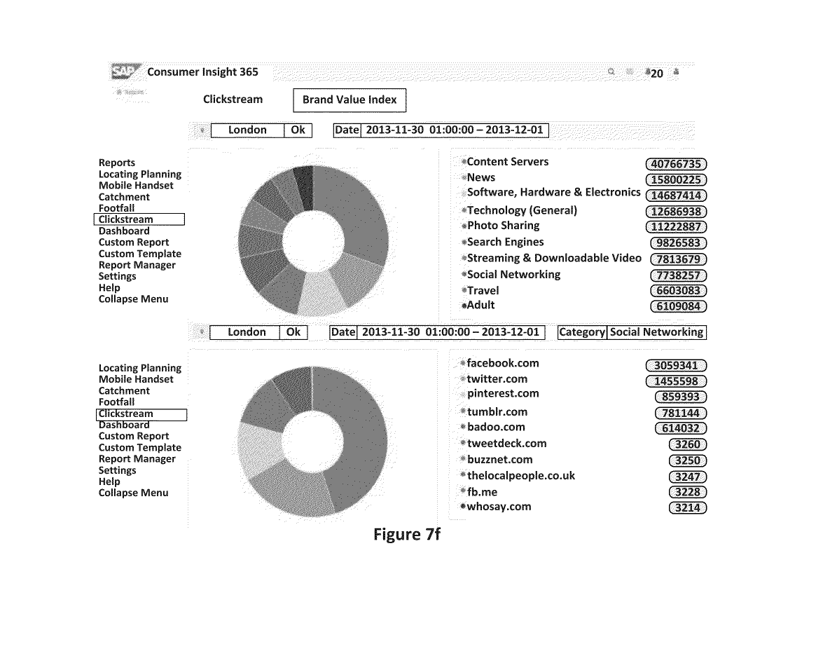

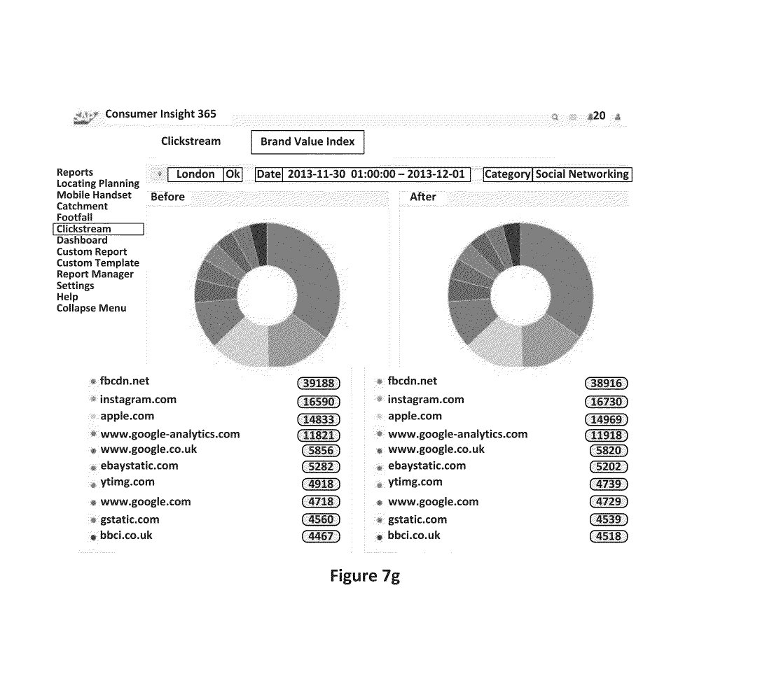

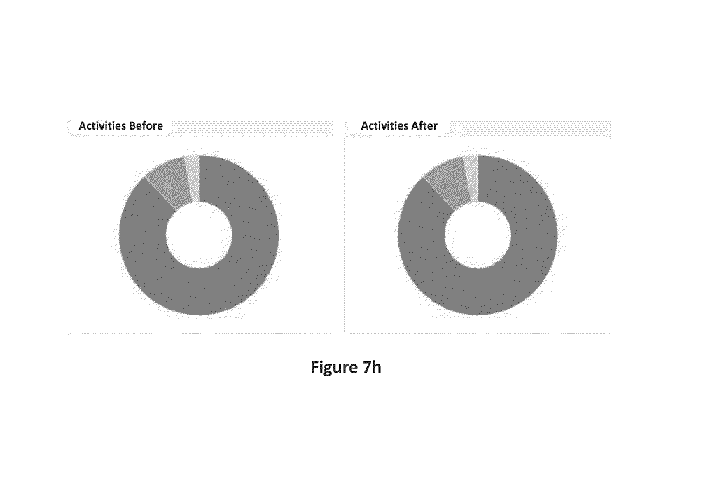

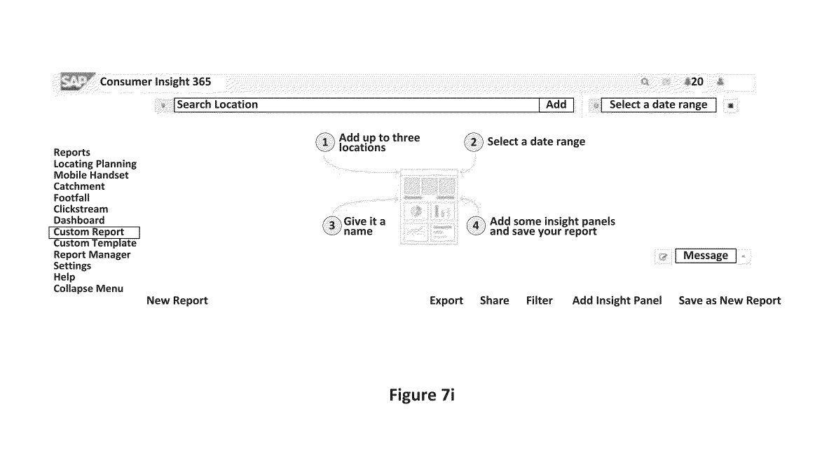

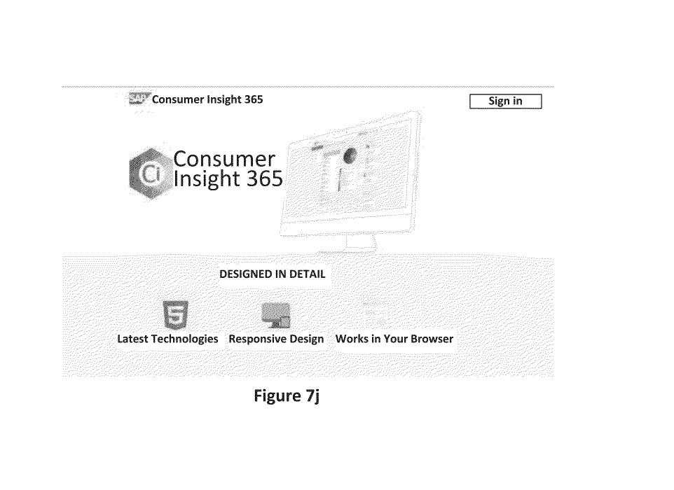

FIGS. 7a-7j illustrate example user interface screens consistent with embodiments described herein. More specifically, an SP may make available to a DC through any one of several possible channels, including private and public network connections, any one or more of the following user interface screens that enable a DC user to learn about, explore, visualize, etc. aspects of the data and processing results that were described above (such as inter alia the predictions, assessments, rankings, aggregations, etc. that an SP developed during various of its processing activities).

User interface screens include, but are not limited to:

Catchment (see FIG. 7a and FIG. 7b);

Footfall (see FIG. 7c);

Brand Value Index (see FIG. 7d and FIG. 7e);

Clickstream (see FIG. 7f, FIG. 7g, and FIG. 7h); and

Custom Report (see FIG. 7i).

Other (such as inter alia and for example FIGS. 11a11c).

Such user interfaces may employ one or more start or landing pages (a hypothetical example of which is illustrated by FIG. 7j) and may optionally comprise inter alia login in, help, lookup, etc. facilities.

Such user interfaces may employ any combination of one or more contexts including inter alia spatial, non-spatial, temporal, etc. to support among other things the ability to report on, analyze, etc. things such as brand activity and trends, device activity and trends, mobile application activity and trends, etc.

Such user interfaces may support a range of capabilities such as inter alia ranking, ordering, etc. (e.g., top 10, top 20, top n, most relevant, least relevant, etc.); location selection/refinement/etc. (e.g., a POI, a street, a neighborhood, a town or city, a custom/arbitrary/etc. geographic region, etc.); time period selection/refinement/etc.; traveling (walking, bicycling, driving, etc.) time and distance mechanisms; various topographic regions (e.g., square, rectangle, circle, triangle, polygon, irregular shape, etc.); etc.

Such user interfaces may support one or more Insight Panels where a user may inter alia add, define, identify, etc. things like disclaimers, definitions, constraints, advertisements, etc. and to which a user may add any combination of one or more tables, charts, graphs, etc.

Such user interfaces may offer a DC user a range of predefined artifacts such as reports, templates, search criteria, preferences, profiles, etc. Additionally, such user interfaces may allow a DC user to for example and inter alia define, save, retrieve, modify, etc. various custom artifacts such as reports, templates, search criteria (e.g., time periods such as ‘Summer Season,’ location(s), etc.), preferences, profiles, etc.

Such user interfaces may offer one or more mechanisms to highlight, annotate, overlay, etc. artifacts such as for example DP infrastructure elements. For example, for a DP cell tower, antenna, etc. information on coverage area geometry (circle, wedge, etc.), signal strength, etc. may be included.

Such user interfaces may offer various drill-down features, capabilities, etc. through which for example a user may explore, retrieve additional information on, etc. different pieces of data.

A DC user's interactions with a user interface may result in among other things an SP completing a range of processing activities including among other things the examination, parsing, augmentation, manipulation, replacement, checking, editing, validation, mapping, aggregation, enhancement, etc. of one or more elements of data received from a DP with the optional preservation of aspects of the results, outcome, etc. of various of the activities in for example one or more repositories.

Such user interfaces may comprise any combination of one or more textual elements, graphic elements, etc. including inter alia descriptive text, charts, graphs, tables, (tree, thematic, choropleth, heat, etc.) maps, icons, labels, links or references, etc. and may be offered through any combination of one or more of inter alia web-based applications (incorporating for example HTML5, CSS, JavaScript, etc.), hybrid applications (incorporating for example containerization, etc.), native applications, etc.

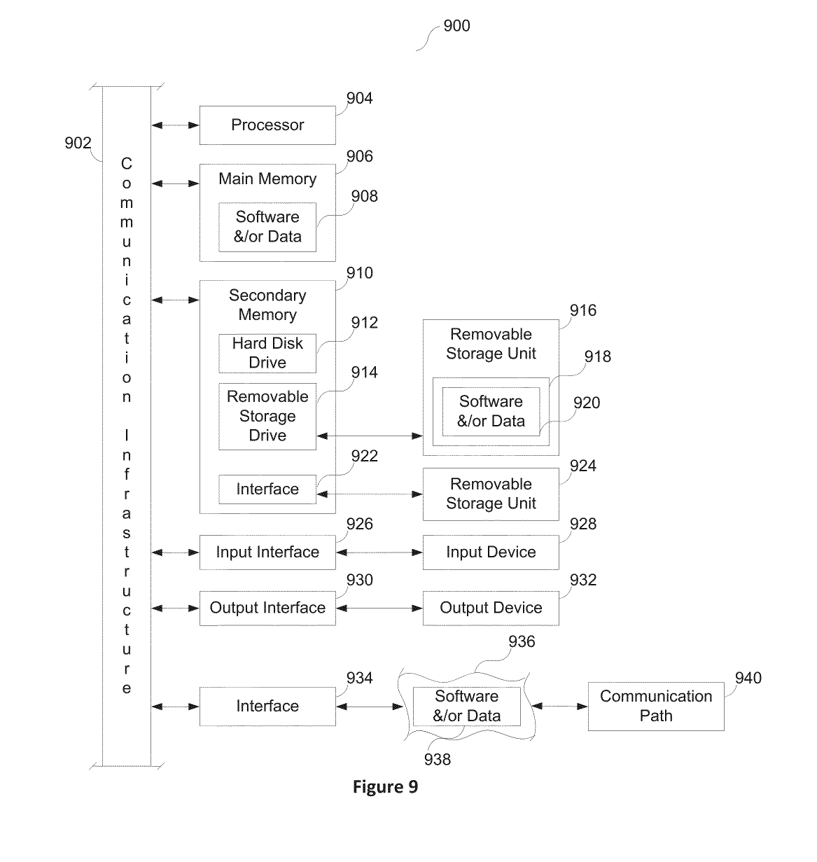

Aspects of the above can be implemented by software, firmware, hardware, or any combination thereof FIG. 9 illustrates an example computer system 900 in which the above, or portions thereof, may be implemented as computer-readable code. Various embodiments of the above are described in terms of this example computer system 900. After reading this description, it will become apparent to a person skilled in the relevant art how to implement the embodiments described herein using other computer systems and/or computer architectures.

Computer system 900 includes one or more processors, such as processor 904. Processor 904 can be a special purpose processor or a general purpose processor. Processor 904 is connected to a communication infrastructure 902 (for example, a bus or a network).

Computer system 900 also includes a main memory 906, preferably Random Access Memory (RAM), containing possibly inter alia computer software and/or data 908.

Computer system 900 may also include a secondary memory 910. Secondary memory 910 may include, for example, a hard disk drive 912, a removable storage drive 914, a memory stick, etc. A removable storage drive 914 may comprise a floppy disk drive, a magnetic tape drive, an optical disk drive, a flash memory, or the like. A removable storage drive 914 reads from and/or writes to a removable storage unit 916 in a well-known manner. A removable storage unit 916 may comprise a floppy disk, magnetic tape, optical disk, etc. which is read by and written to by removable storage drive 914. As will be appreciated by persons skilled in the relevant art(s) removable storage unit 916 includes a computer usable storage medium 918 having stored therein possibly inter alia computer software and/or data 920.

In alternative implementations, secondary memory 910 may include other similar means for allowing computer programs or other instructions to be loaded into computer system 1400. Such means may include, for example, a removable storage unit 924 and an interface 922. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 924 and interfaces 922 which allow software and data to be transferred from the removable storage unit 924 to computer system 900.

Computer system 900 may also include an input interface 926 and a range of input devices 928 such as, possibly inter alia, a keyboard, a mouse, etc.

Computer system 900 may also include an output interface 930 and a range of output devices 932 such as, possibly inter alia, a display, one or more speakers, etc.

Computer system 900 may also include a communications interface 934. Communications interface 934 allows software and/or data 938 to be transferred between computer system 900 and external devices. Communications interface 934 may include a modem, a network interface (such as an Ethernet card), a communications port, a Personal Computer Memory Card International Association (PCMCIA) slot and card, or the like. Software and/or data 938 transferred via communications interface 934 are in the form of signals 936 which may be electronic, electromagnetic, optical, or other signals capable of being received by communications interface 934. These signals 936 are provided to communications interface 934 via a communications path 940. Communications path 940 carries signals and may be implemented using wire or cable, fiber optics, a phone line, a cellular phone link, a Radio Frequency (RF) link or other communications channels.

As used in this document, the terms “computer program medium,” “computer usable medium,” and “computer readable medium” generally refer to media such as removable storage unit 916, removable storage unit 924, and a hard disk installed in hard disk drive 912. Signals carried over communications path 940 can also embody the logic described herein. Computer program medium and computer usable medium can also refer to memories, such as main memory 906 and secondary memory 910, which can be memory semiconductors (e.g. Dynamic Random Access Memory (DRAM) elements, etc.). These computer program products are means for providing software to computer system 900.

Computer programs (also called computer control logic) are stored in main memory 906 and/or secondary memory 910. Computer programs may also be received via communications interface 934. Such computer programs, when executed, enable computer system 900 to implement the present invention as discussed herein. In particular, the computer programs, when executed, enable processor 904 to implement the processes of aspects of the above. Accordingly, such computer programs represent controllers of the computer system 900. Where the invention is implemented using software, the software may be stored in a computer program product and loaded into computer system 900 using removable storage drive 914, interface 922, hard drive 912 or communications interface 934.

The invention is also directed to computer program products comprising software stored on any computer useable medium. Such software, when executed in one or more data processing devices, causes data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), nanotechnological storage device, etc.), and communication mediums (e.g., wired and wireless communications networks, local area networks, wide area networks, intranets, etc.).

Based on the teachings contained in this disclosure, it will be apparent to persons skilled in the relevant art(s) how to make and use the invention using data processing devices, computer systems, and/or computer architectures other than that shown in FIG. 9. In particular, embodiments may operate with software, hardware, and/or operating system implementations other than those described herein.

For simplicity of exposition the above discussion focused principally on telecommunications generally and mobile operators specifically. It will be readily apparent to one of ordinary skill in the relevant art that numerous other contexts are easily possible including inter alia transportation environments, IoT/M2M environment, etc.

The above description is intended by way of example only. It will be readily apparent to one of ordinary skill in the relevant art that various modifications and structural changes may be made therein without departing from the scope of the concepts described herein and within the scope and range of equivalents of the claims.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

What is claimed is:

1. A computer-implemented method comprising:
collecting data from a plurality of wireless devices, wherein the collected data includes recorded activity at the wireless devices;
at a processor of a computer, analyzing the collected data to produce demographic data, wherein the analyzing includes calculating, based on the collected data, probabilities of individual steps in a path, and wherein each step represents a visit to one of (i) a website in the path and (ii) a physical location in the path; and
supplying the demographic data to a data consumer device.

2. The method of claim 1, wherein the recorded activity includes movement of the wireless devices in relation to at least one physical location relevant to the analysis.

3. The method of claim 2, further comprising:
forming a plurality of virtual cells based on locations of transmission hardware operated by a telecommunications provider, wherein the analysis includes dividing the wireless device users into groups based on their locations within the virtual cell, and wherein the virtual cells include the at least one physical location.

4. The method of claim 3, further comprising:
deriving coordinates of each virtual cell from latitude and longitude coordinates.

5. The method of claim 4, further comprising:
calculating, as anchor points by which virtual cells are referenced, coordinates of a center of each virtual cell.

6. The method of claim 1, wherein the recorded activity includes Internet browsing, and wherein the analysis includes identifying a plurality of websites visited by a particular wireless device.

7. The method of claim 6, wherein the analysis includes identifying a sequence in which the plurality of websites was visited by the wireless device.

8. The method of claim 1, wherein the analysis includes calculating a Brand Value Index (BVI) for a business entity based on one of (i) an amount of time that wireless device users stayed on a website of the business entity and (ii) an amount of time that wireless device users stayed at a physical location of the business entity, in relation to a corresponding amount of time from wireless device users of competitor entities.

9. The method of claim 1, wherein the analysis includes calculating a Brand Value Index (BVI) for a business entity based on a number of clicks received at a website of the business entity, in relation to a number of clicks received at websites of competitor entities.

10. The method of claim 1, wherein the analysis includes calculating a Brand Value Index (BVI) for a business entity based on one of (i) a number of wireless device users that returned to a website of the business entity and (ii) a number of wireless device users that returned to a physical location of the business entity, in relation to a corresponding number of returned users of competitor entities.

11. An apparatus comprising:
a computer device configured to:
collect data from a plurality of wireless devices, wherein the collected data includes recorded activity at the wireless devices;
analyze the collected data to produce demographic data, wherein the analyzing includes calculating, based on the collected data, probabilities of individual steps in a path, and wherein each step represents a visit to one of (i) a website in the path and (ii) a physical location in the path; and
supply the demographic data to a data consumer device.

12. The apparatus of claim 11, wherein:
the computer device is configured to form a plurality of virtual cells based on locations of transmission hardware operated by a telecommunications provider;
the analysis includes dividing wireless device users into groups based on their locations within the virtual cell; and
the virtual cells include at least one physical location relevant to the analysis.

13. The apparatus of claim 12, wherein the computer device is configured to derive coordinates of each virtual cell from latitude and longitude coordinates.

14. The apparatus of claim 13, wherein the computer device is configured to calculate, as anchor points by which virtual cells are referenced, coordinates of a center of each virtual cell.

15. The apparatus of claim 11, wherein the recorded activity includes Internet browsing, and wherein the analysis includes identifying a plurality of websites visited by a particular wireless device.

16. The apparatus of claim 15, wherein the analysis includes identifying a sequence in which the plurality of websites was visited by the wireless device.

17. The apparatus of claim 11, wherein the analysis includes calculating a Brand Value Index (BVI) for a business entity based on one of (i) an amount of time that wireless device users stayed on a website of the business entity and (ii) an amount of time that wireless device users stayed at a physical location of the business entity, in relation to a corresponding amount of time from wireless device users of competitor entities.

18. The apparatus of claim 11, wherein the analysis includes calculating a Brand Value Index (BVI) for a business entity based on a number of clicks received at a website of the business entity, in relation to a number of clicks received at websites of competitor entities.

19. The apparatus of claim 11, wherein the analysis includes calculating a Brand Value Index (BVI) for a business entity based on one of (i) a number of wireless device users that returned to a website of the business entity and (ii) a number of wireless device users that returned to a physical location of the business entity, in relation to a corresponding number of returned users of competitor entities.

20. A non-transitory computer readable medium containing program instructions, wherein execution of the program instructions by one or more processors of a computer system causes one or more processors to carry out the steps of:
collecting data from a plurality of wireless devices, wherein the collected data includes recorded activity at the wireless devices;
analyzing the collected data to produce demographic data, wherein the analyzing includes calculating, based on the collected data, probabilities of individual steps in a path, and wherein each step represents a visit to one of (i) a website in the path and (ii) a physical location in the path; and
supplying the demographic data to a data consumer device.
